(19) United States
(12) Patent Application Publication
(10) Pub. No.: US 2010/0266926 A1
(43) Pub. Date: Oct. 21, 2010

(54) FUEL CELL ELECTROLYTE MEMBRANE, MEMBRANE ELECTRODE ASSEMBLY, AND FUEL CELL

(76) Inventors: Takayuki Hirashige, Hitachi (JP); Takao Ishikawa, Hitachi (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/063,687

(22) PCT Filed: Oct. 1, 2007
(86) PCT No.: PCT/JP2007/069172

§ 371 Date: Jul. 2, 2010

(30) Foreign Application Priority Data
Oct. 2, 2006 (JP) 2006-270256

(51) Int. Cl. H01M 8/10

(52) U.S. Cl. 429/479

(57) ABSTRACT

A proton-conductive composite electrolyte membrane, for a fuel cell, comprises a metal-oxide hydrate with proton conductivity and organic macromolecules in which an intermediate layer is formed between the metal-oxide hydrate and the first organic macromolecular electrolyte. The intermediate layer can enhance the adhesion at an interface between the metal-oxide hydrate and the organic macromolecule, and thereby the amount of methanol that penetrates along the interface can be reduced. Accordingly, the composite electrolyte membrane has both high proton conductivity and low methanol permeability, and a membrane electrode assembly that comprises the composite electrolyte membrane can produce a high output.

### BACKGROUND OF THE INVENTION

1. Field of the Invention

The present invention relates to a fuel cell electrolyte membrane, membrane electrode assembly, and fuel cell.

2. Description of Related Art

In recent years, inorganic-organic composite electrolyte membranes formed by combining inorganic and organic substances have attracted much attention as electrolyte membranes that have both high proton conductivity and low methanol permeability. In, for example, Patent Document 1 (Japanese Patent Laid-open No. 2003-331869), an electrolyte membrane in which metal-oxide hydrate is dispersed in an organic macromolecule is reported.

### Patent Document 1: Japanese Patent Laid-open No. 2003-331869

### PROBLEMS TO BE SOLVED BY THE INVENTION

However, it can be said at present that the performance of the reported composite electrolyte membrane is not sufficient. Specifically, the amount of methanol permeation cannot be sufficiently suppressed. Another problem is that since an inorganic substance is included, the amount of methanol permeation increases conversely.

A probable reason why the amount of methanol permeation increases is that the adhesion at an interface between the inorganic and the organic substances is prone to decrease because they are heterogeneous with each other. Clearances are thereby generated at the interface between the inorganic and the organic substances, through which methanol permeates.

Therefore, it can be considered that even when an inorganic-organic composite electrolyte membrane is prepared as an electrolyte membrane intended to have both high proton conductivity and low methanol permeability, the electrolyte membrane cannot sufficiently provide desired performance.

### SUMMARY OF THE INVENTION

Under these circumstances, the present invention addresses the above problems. It is an object of the present invention to provide an inorganic-organic composite electrolyte membrane that maintains high proton conductivity and has low methanol permeability; the amount of methanol permeation can be reduced by increasing the adhesion at the interface between the inorganic and the organic substances. It is further object of the present invention is to provide a high-output membrane electrode assembly (MEA) that uses the inorganic-organic composite electrolyte membrane as well as a fuel cell that uses the MEA.

### MEANS FOR SOLVING THE PROBLEMS

A proton-conductive composite electrolyte membrane for a fuel cell of the present invention comprises a metal-oxide hydrate with proton conductivity and a first organic macromolecular electrolyte in which an intermediate layer is formed so as to enhance adhesion between the metal-oxide hydrate and the first organic macromolecular electrolyte. A membrane electrode assembly and a fuel cell of the present invention use the proton-conductive composite electrolyte membrane.

### ADVANTAGES OF THE INVENTION

According to the present invention, it is possible to provide an electrolyte membrane with low methanol permeability while maintaining the proton conductivity of a conventional proton-conductive composite electrolyte membrane, and thereby to provide a high-output MEA and fuel cell that uses the inventive electrolyte membrane.

### BRIEF DESCRIPTION OF THE DRAWINGS

FIG. 1 is a schematic illustration showing a model of a conventional composite electrolyte membrane comprising organic macromolecules and metal-oxide hydrate having proton conductivity.

FIG. 2 is a schematic illustration showing a model of a composite electrolyte membrane according to the present invention; the composite electrolyte membrane has a high adhesion between the metal-oxide hydrate and the organic macromolecule.

FIG. 3 is a schematic illustration showing a cross sectional view of an example of a fuel cell according to the present invention.

FIG. 4 is a schematic illustration showing an exploded view of another fuel cell according to the present invention.

FIG. 5 is a schematic illustration showing a perspective view of the fuel cell in FIG. 4 according to the present invention.

FIG. 6 is a graph showing the proton conductivities of the electrolyte membranes in Example 1 according to the present invention, Comparative example 1, and Comparative example 2.

FIG. 7 is a graph showing the amounts of methanol penetration of MEAs using the electrolyte membranes in Example 1 according to the present invention, Comparative example 1, and Comparative example 2.

FIG. 8 is a graph showing the I-V characteristics of MEAs using the electrolyte membranes in Example 1 according to the present invention, Comparative example 1, and Comparative example 2.

### LEGEND

11, 21: organic macromolecules
12, 22: metal-oxide hydrate
23: intermediate layer
31: bipolar plate
32: composite electrolyte membrane of present invention
33: anode catalyst layer
34: cathode catalyst layer
35: gas diffusion layer
36, 43: gasket
41: fuel chamber
42, 52: anode end plate
44: diffusion layer-equipped MEA
45, 53: cathode end plate
46: terminal
47, 59: cartridge holder
48, 57: screw
51: fuel chamber
54: connection terminal
55: gas exhaust port
56: output terminal
58: fuel cartridge

### DETAILED DESCRIPTION OF THE PREFERRED EMBODIMENTS

### Best Mode for Carrying Out the Invention

A composite electrolyte membrane, in a best embodiment of the present invention, that comprises metal-oxide hydrate with proton conductivity and organic macromolecules has an intermediate layer between the metal-oxide hydrate and the organic macromolecule. The intermediate layer enhances the adhesion between the metal-oxide hydrate and the organic macromolecule.

The intermediate layer comprises organic macromolecules having a higher hydrophilic than the bulk organic macromolecule. Alternatively, the intermediate layer is a functional group or surfactant that enhances the adhesion between the metal-oxide hydrate and the organic macromolecule. The composite electrolyte membrane in the embodiment can enhances the adhesion between the metal-oxide hydrate and the organic macromolecule, and thereby achieves both high proton conductivity and low methanol permeability. Furthermore, the composite electrolyte membrane can be used to provide a membrane electrode assembly (MEA) for a high-output direct methanol fuel cell (DMFC).

Preferred embodiments of the present invention will be described in detail with reference to the drawings. However, the present invention is not limited to the embodiments described herein.

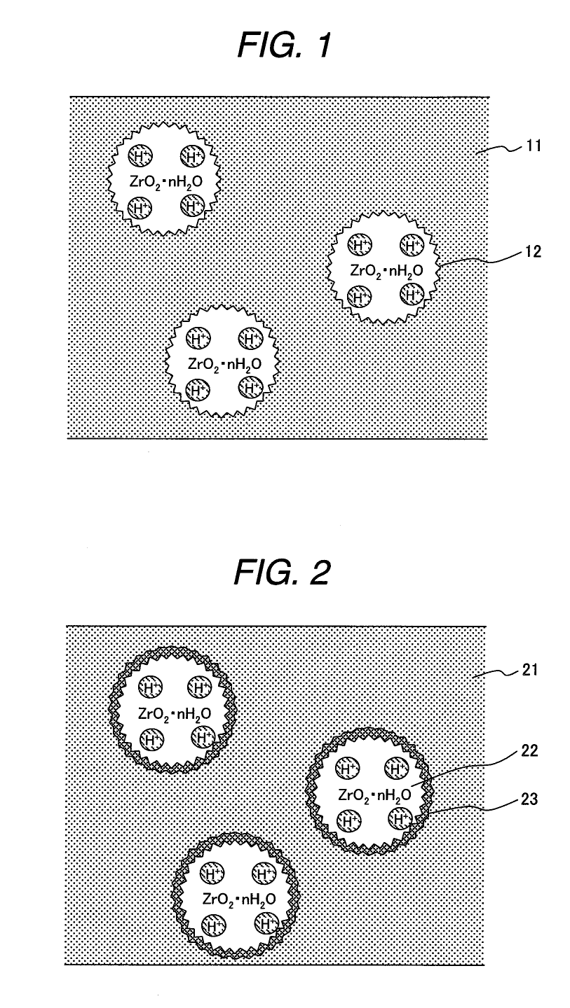

FIG. 1 is a schematic illustration showing a model of a conventional a composite electrolyte membrane comprising organic macromolecules and metal-oxide hydrate having proton conductivity. In FIG. 1 are shown an organic macromolecule 11 having a proton donor such as the sulfonic acid group, and metal-oxide hydrate 12 having proton conductivity. In the drawing, zirconium oxide hydrate ZrO₂.nH₂O is indicated as a specific example of the metal-oxide hydrate. The organic macromolecule is proton conductive when it is under a hydrous state. This is because, under the hydrous state, protons are dissociated from the proton donor such as the sulfonic acid group and then are conducted. If this organic macromolecule is used in a direct methanol fuel cell (DMFC), methanol and water are mutually dissolved since they are almost the same in size. The methanol thereby also penetrates through the organic macromolecule.

On the other hand, in the metal-oxide hydrate, protons conduct via hydrates in crystals. The hydrate in the crystal is fixed in it and cannot move. Ease of motion of the water is associated with that of the methanol as described above, so the methanol cannot move in a place where the water cannot move, preventing the methanol from moving in the metal-oxide hydrate. The metal-oxide hydrate has relatively high proton conductivity as an inorganic substance. For example, at 25° C., zirconium oxide hydrate ZrO₂.nH₂O has a proton conductivity of 2.8×10⁻³ S/cm, and tin oxide hydrate SnO₂.nH₂O has a proton conductivity of 4.7×10⁻³ S/cm. When a composite electrolyte membrane is formed by combining organic macromolecules and metal-oxide hydrate that have different mechanisms by which protons and methanol conduct, as described above, it can be anticipated that an electrolyte membrane, which blocks methanol permeation and allows protons to permeate, can be obtained. That is, it can be expected that relationship of the tradeoff between proton conductivity and the methanol permeability as seen in an electrolyte membrane comprising only organic macromolecules can be improved.

In practice, however, since a metal-oxide hydrate is included, the amount of methanol permeation can be considered to increase, as compared with the electrolyte membrane comprising only organic macromolecules. In particular, the amount of methanol permeation is prone to increase with increasing the amount of metal-oxide hydrate.

A probable reason for this increase in the amount of methanol permeation is low adhesion between the metal-oxide hydrate and the organic macromolecule. Therefore, clearances are easy to be formed between the metal-oxide hydrate and the organic macromolecule, and methanol permeates through these clearances.

It can be considered that a reason for the low adhesion between the metal-oxide hydrate and the organic macromolecule is a difference in hydrophilic. The proton donor at the terminal of a side chain of the organic macromolecule has a hydrophilic property, but the main chain has a hydrophobic property. By comparison, the metal-oxide hydrate has a hydrophilic property because it has hydrate in its structure. Accordingly, a repulsive force acts on a part where the hydrophobic part of the organic macromolecule and the metal-oxide hydrate are brought into mutual contact, thereby degrading the adhesion between them.

From the above reason, as the content of metal-oxide hydrate included in a composite electrolyte membrane comprising metal-oxide hydrate and organic macromolecules increases, the amount of methanol permeation tends to increase. It can be assumed that as the content of metal-oxide hydrate included increases, more chances to contact the hydrophobic part of the organic macromolecule increase. In addition, as the ion exchange capacity of the organic macromolecule becomes smaller, the amount of methanol that penetrates through the composite electrolyte membrane including metal-oxide hydrate increases. A probable reason for this is that as the ion exchange capacity of the organic macromolecule becomes smaller, the hydrophobic part of the organic macromolecule is enlarged and thereby repulsive forces act on more regions of the metal-oxide hydrate.

As described above, the conventional inorganic-organic composite electrolyte membrane is not an electrolyte membrane that can achieve both targeted high proton conductivity and a low amount of methanol permeation because of a low adhesion between the inorganic substance and the organic macromolecule.

FIG. 2 is a schematic illustration showing a model of a composite electrolyte membrane according to the present invention; the composite electrolyte membrane has a high adhesion between the metal-oxide hydrate and the organic macromolecule. In FIG. 2 are shown an organic macromolecule 21 having a proton donor such as the sulfonic acid group, metal-oxide hydrate 22 having proton conductivity, and an intermediate layer 23. In the drawing, zirconium oxide hydrate ZrO₂.nH₂O is indicated as a specific example of the metal-oxide hydrate. The intermediate layer 23 is introduced to increase the adhesion between the metal-oxide hydrate and the organic macromolecule.

This intermediate layer according to the present invention can increase the adhesion between the metal-oxide hydrate and the organic macromolecule and thereby prevent the amount of methanol permeation from increasing.

The following can be used as this intermediate layer.

(1) Organic macromolecule having a higher hydrophilic than bulk organic macromolecule

(2) Functional groups that increase an affinity between the metal-oxide hydrate and the organic macromolecule

(3) Surfactants that combine a hydrophobic group with a hydrophilic group

Here, the bulk refers to organic macromolecules other than in the intermediate layer formed on the surface of the metal-oxide hydrate in a composite electrolyte membrane comprising metal-oxide hydrate and organic macromolecules.

Macromolecules having a higher hydrophilic than the bulk organic macromolecule in (1) include an organic macromolecule having a higher concentration of ion exchange group. This type of organic macromolecule may have the same skeleton as the bulk or may have a different skeleton from the bulk. Functional groups that increase the affinity between the metal-oxide hydrate and the organic macromolecule in (2) include the sulfonic acid group, phosphonic acid group, carboxyl group, phosphate group, and hydroxy group. When any of these functional groups is bonded to the surface of the metal-oxide hydrate or the organic macromolecule, an intermediate layer can be formed.

Since the above intermediate layer increases the affinity between the metal-oxide hydrate and the organic macromolecule, the adhesion therebetween can be increased and the amount of methanol that permeates along the interface can be reduced.

When the intermediate layer is too thin, it has no effect to increase the adhesion. The thickness of the intermediate layer is preferably 10 nm or more. By contrast, it is hard to form a very thick intermediate layer, so the thickness of the intermediate layer is preferably 10 μm or less.

Means for checking whether an intermediate layer is formed include element analysis and energy dispersive X-ray spectroscopy (EDX) analysis using a scanning electron microscopy (SEM) or a transmission electron microscopy (TEM). In a check method based on EDX, when an organic macromolecule is used in which the proton donor is, e.g., the sulfonic acid group for both the bulk and intermediate layer, the concentration of the sulfur atom S included in the sulfonic acid group may be compared. That is, formation of the intermediate layer can be confirmed from a ratio between a peak of the sulfur atom S in the intermediate layer on the surface of the metal-oxide hydrate and a peak of the sulfur atom S in the bulk.

Meanwhile, the inorganic-organic composite electrolyte membrane can also be used in a polymer electrolyte fuel cell (PEFC) in which hydrogen is used as a fuel instead of methanol in DMFC. When the inorganic-organic composite electrolyte membrane comprising metal-oxide hydrate and organic macromolecules is used in the PEFC, it is advantageous in that an operation temperature can be made higher than a normal operation temperature (70 to 80° C.).

The metal-oxide hydrate can retain moisture because it has a hydrate in a crystal. When the metal-oxide hydrate is dispersed in the organic macromolecule, the entire membrane can improve moisture retentivity. When an electrolyte membrane comprising only organic macromolecules, which is generally used, is heated to a high temperature, its moisture is evaporated, lowering the proton conductivity. So, maximum allowable temperatures are approximately 70 to 80° C. For the composite electrolyte membrane, in which the metal-oxide hydrate is dispersed so as to retain moisture, however, it is possible to prevent the proton conductivity from lowering even at high temperatures. A high operation temperature is advantageous in that, e.g., a high output is obtained, that the amount of precious metal catalysts such as Pt can be reduced, and that waste heat can be used effectively.

However, when the conventional inorganic-organic composite electrolyte membrane is used in the PEFC, the same problem as in the DMFC occurs. That is, since the adhesion at the interface between the inorganic substance and the organic substance is low, the hydrogen gas or air included in the fuel passes through clearances at the interface. This phenomenon limits the output of the PEFC.

The composite electrolyte membrane according to the present invention, which comprises metal-oxide hydrate having proton conductivity and organic macromolecules and has an intermediate layer between the metal-oxide hydrate and the organic macromolecule, can also be applied to a PEFC. In particular, the composite electrolyte membrane can also be applied to a high-temperature PEFC, the operation temperature of which is higher than 80° C. In the preferred embodiment of the present invention, the operation temperature of the PEFC can be raised up to approximately 100° C. The inventive composite electrolyte membrane, in which the adhesion between the metal-oxide hydrate and the organic macromolecule is increased, enables the PEFC to provide a high output.

Metal-oxide hydrates having proton conductivity that can be used in the preferred embodiment of the present invention include zirconium oxide hydrate, tungsten oxide hydrate, tin oxide hydrate, niobium doped tungsten oxide hydrate, silicon dioxide hydrate, phosphorus oxide hydrate, zirconium doped silicon dioxide hydrate, tungstophosphoric acid hydrate, and molybdophosphoric acid hydrate. Alternatively, two or more of these metal-oxide hydrates can be combined. Zirconium oxide hydrate is particularly preferable as metal-oxide hydrate to be dispersed in an electrolyte membrane for a high-temperature PEFC.

Organic macromolecules that can be used in the preferred embodiment of the present invention include perfluorocarbonsulfonate. Alternatively, a proton donor such as the sulfonic acid group, phosphonic acid group, or carboxyl group may be doped or may be chemically combined or fixed to an engineering plastic material such as polystyrene, polyetherketone, polyetheretherketone, polysulfone, or polyethersulfone. These materials may have a cross-linked structure or may be partially fluorinated so as to increase their stability.

In the composite electrolyte membrane in the preferred embodiment according to the present invention, which comprises metal-oxide hydrate having proton conductivity and organic macromolecules, a requirement for the organic macromolecule is that it has suitable hydrophilic property. This is because a membrane is hard to form unless the organic macromolecules in the bulk and intermediate layer have a hydrophilic property to some extent. The hydrophilic property of an organic macromolecule is determined by the concentration of an ion exchange group such as the sulfonic acid group or carboxyl group. The ion exchange capacity q (meq/g) indicated by an equivalent weight per gram is used as index of the ion exchange group concentration; the larger the ion exchange capacity is, the higher the exchange group concentration is. The ion exchange can be measured by ¹H-NMR spectroscopy, element analysis, the acid-base titration described in Description in Japanese Patent No. 1 (1989)-52866, non-aqueous acid-base titration (a benzene methanol solution of potassium methoxide is used as a normal solution), and the like. To provide a hydrophilic property so that the metal-oxide hydrate is uniformly dispersed, the ion exchange capacity is preferably 0.75 meq/g or more per unit organic macromolecule dry weight for both the bulk and intermediate layer. However, when the ion exchange capacity is too large, the organic macromolecule is prone to dissolve in the methanol solution, shortening its life. Accordingly, the ion exchange capacity is preferably 1.67 meq/g or less per unit organic macromolecule dry weight for both the bulk and intermediate layer. The ion exchange capacity is further preferably 1.4 meg/g or less.

When the content of the metal-oxide hydrate to be dispersed in the organic macromolecule is 5 wt % or less, there is almost no effect. When the content is 80 wt % or more, the metal-oxide hydrate is prone to aggregate, impeding a membrane from being formed. Accordingly, the content of the metal-oxide hydrate is preferably more than 5 wt % and less than 80 wt % and further preferably 10 to 60 wt %.

As methods of forming an intermediate layer between the organic macromolecule and the metal-oxide hydrate in the preferred embodiment of the present invention, when the hydrophilic of the macromolecule in the intermediate layer needs to be higher than that of the bulk organic macromolecule, two dispersion methods can be used; (i) simple dispersion method and (ii) precursor dispersion method.

In the simple dispersion method of (i), an intermediate layer is coated on the surface of the metal-oxide hydrate, and then the metal-oxide hydrate is dispersed in the organic macromolecule. Specifically, powder of the metal-oxide hydrate is synthesized in advance. The powder is mixed with varnish in which the organic macromolecule is dissolved in a solvent, after which the solvent is evaporated. The organic macromolecule can be thereby coated on the surface of the metal-oxide hydrate. The metal-oxide hydrate, the surface of which is coated, is mixed with another varnish in which the organic macromolecule is dissolved in a solvent. The mixed varnish is used to form a membrane on a substrate, and the solvent is then evaporated, producing an inorganic-organic composite electrolyte membrane having high adhesion on the interface.

In the precursor dispersion method of (ii), an intermediate layer is coated on the surface of a precursor of the metal-oxide hydrate, and then the precursor of the metal-oxide hydrate is dispersed in the organic macromolecule; after a membrane is formed on a substrate, a chemical reaction is taken place on the precursor to precipitate the metal-oxide hydrate. Specifically, the precursor of the metal-oxide hydrate is mixed with varnish in which the organic macromolecule is dissolved in a solvent, the resulting mixture is stirred, and the solvent is evaporated. As a result, the organic macromolecule is coated on the surface of the precursor of the metal-oxide hydrate. The precursor, the surface of which is coated, is mixed with another varnish in which the organic macromolecule is dissolved in a solvent. The mixed varnish is used to form a membrane on a substrate, and the solvent is evaporated, producing a membrane. After that, a chemical reaction is taken place on the precursor in the membrane to precipitate the metal-oxide hydrate in the membrane, producing an inorganic-organic composite electrolyte membrane having high adhesion on the interface.

Of these two fabrication methods, the precursor dispersion method of (ii) is preferable from the viewpoint of dispersion of the metal-oxide hydrate.

When the intermediate layer of the organic macromolecule is coated on the surface of the metal-oxide hydrate or its precursor, if the concentration of the organic macromolecule dissolved in the varnish or a stirring time is changed, the thickness of the intermediate layer to be coated can be changed.

As a method of forming a functional group on the surface of inorganic oxide hydrate, plasma emission or the like can be used.

There is no restriction on the means for forming a membrane; e.g., a dip coating method, spray coating method, roll coating method, doctor blade method, gravure coating method, or screen printing method can be used. There is also no restriction on the substrate if a membrane can be formed and the formed membrane can be peeled; e.g., a glass plate, polytetrafluoroethylene sheet, or polyimide sheet can be used. In the mixing method, e.g., a stirrer, a ball mill, Nanomill (registered trademark), or ultrasonic can be used.

There is no restriction on the solvent in which to dissolve the organic macromolecule if the organic macromolecule can be dissolved in the solvent and then can be removed. A non-proton polar solvent such as N,N-dimethylformamide, N,N-dimethylacetamide, N-methyl-2-pyrrolidone, or dimethylsulfoxide; a halogen solvent such as dichloromethane, trichloroethane, or alkyleneglycolmonoalkylether such as ethyleneglycolmonomethylether, ethyleneglycolmonoethylether, propyleneglycolmonomethylether, or propyleneglycolmonoethylether; or alcohol such as isopropyl alcohol or tertiarybutyl alcohol can be used.

There is no restriction on the thickness of the composite electrolyte membrane in the preferred embodiment of the present invention, but the thickness is preferably 10 to 200 μm. In order to obtain a membrane having a mechanical strength that can withstand practical use, the thickness is preferably more than 10 μm. To reduce the membrane resistance, i.e., to improve electric power generation performance, the thickness is preferably less than 200 μm, particularly preferably 30 to 100 μm. In a solution casting method, the thickness can be controlled by the solution concentration or by the thickness of the coat applied to the substrate. When a membrane is formed from a molten state, the thickness can be controlled by expanding a membrane with a prescribed thickness, which is obtained by a melting and pressing method or by a melting and extruding method, to a prescribed magnification.

The MEA including the composite electrolyte membrane in the preferred embodiment of the present invention can be fabricated by a method described below. Firstly, platinum-supporting carbon, a solid-state macromolecular electrolyte, and a solvent in which to dissolve the solid-state macromolecular electrolyte are sufficiently mixed to form a cathode catalyst paste. In addition, platinum-ruthenium alloy-supporting carbon, a solid-state macromolecular electrolyte, and a solvent in which to dissolve the solid-state macromolecular electrolyte are sufficiently mixed to form an anode catalyst paste. These pastes are each sprayed on a release film such as a polytetrafluoroethylene (PTFE) film by, e.g., a spray dry method, and then are dried at 80° C. to evaporate the solvent, forming a cathode catalyst layer and an anode catalyst layer. Next, the cathode catalyst layer and anode catalyst layer are joined with the inventive composite electrolyte membrane intervening therebetween by a hot-pressing method. When the release film is peeled, the MEA including the composite electrolyte membrane according to the present invention is formed.

Another exemplary method of forming the MEA including the inventive composite electrolyte membrane will be described below. As described above, platinum-supporting carbon, a solid-state macromolecular electrolyte, and a solvent in which to dissolve the solid-state macromolecular electrolyte are sufficiently mixed to form a cathode catalyst paste; and platinum-ruthenium alloy-supporting carbon, a solid-state macromolecular electrolyte, and a solvent in which to dissolve the solid-state macromolecular electrolyte are sufficiently mixed to form an anode catalyst paste. These pastes are each directly sprayed on the composite electrolyte membrane according to the present invention by, e.g., a spray dry method.

A macromolecular material having proton conductivity is used as the solid-state macromolecular electrolyte, used in the MEA including the inventive composite electrolyte membrane, which is to be included in the catalyst layer. Exemplary macromolecular materials include polystyrene and fluorinated polymers subject to sulfonated or alkylene-sulfonated typified by, e.g., perfluorocarbonsulfonic acid type resin and polyperfluorostyrenesulfonic acid type resin. Other exemplary macromolecular materials are polysulfone, polyethersulfone, polyetherethersulfone, polyetheretherketone, and materials in which a proton donor such as the sulfonic acid group is included in a hydro-carbon polymer. It is also possible to use the inventive composite electrolyte membrane comprising organic macromolecules and metal-oxide hydrate, as the solid-state macromolecular electrolyte.

Catalyst metals used in this embodiment preferably include at least platinum in the cathode and at least platinum or a platinum alloy including ruthenium in the anode. However, the present invention is not restricted to these catalyst metals; a catalyst in which a third component selected from iron, tin, rare-earth elements, and the like is added to the above noble metals may be used to stabilize the electrode catalyst and prolong its lifetime.

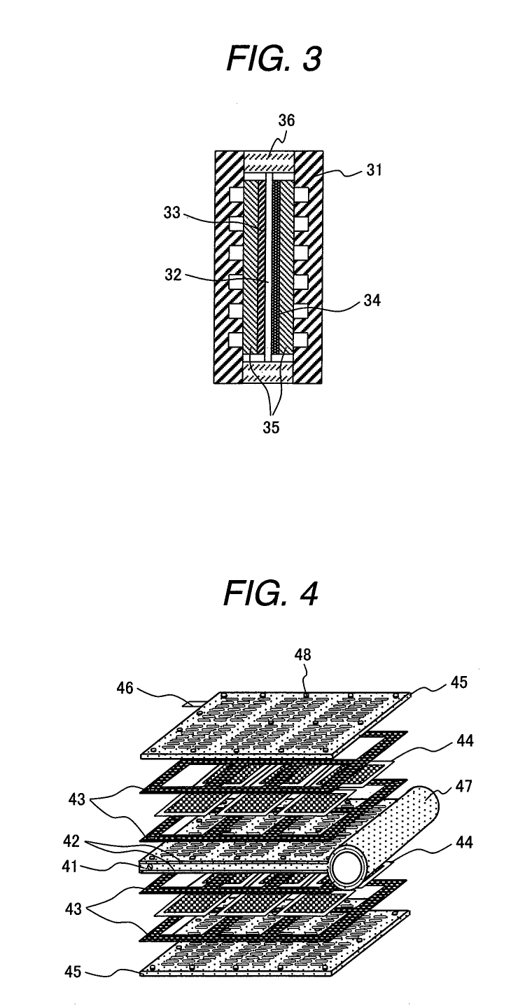

FIG. 3 is a schematic illustration showing a cross sectional view of an example of a direct methanol fuel cell according to the present invention. As shown in FIG. 3, the direct methanol fuel cell includes: bipolar plates 31; a composite electrolyte membrane 32 according to the preferred embodiment of the present invention, which comprises organic macromolecules and metal-oxide hydrate having proton conductivity; an anode catalyst layer 33; a cathode catalyst layer 34; gas diffusion layers 35; and gaskets 36. The composite electrolyte membrane 32 to which the anode catalyst layer 33 and cathode catalyst layer 34 are bonded constitutes an electrolyte membrane assembly (MEA). The bipolar plate 31 is electrically conductive; it is preferably made of a dense graphite plate, a carbon plate molded from a carbon material such as graphite or carbon black through resin, or a metal material with a superior resistance to corrosion such as stainless steel or a titanium material. It is also preferable to perform surface treatment on the surfaces of the bipolar plate 31 by plating them with a noble metal or by applying an electrically conductive coating with a superior resistance to corrosion and heat. Grooves are formed in the surface of one bipolar plate 31 that is brought into contact with the anode catalyst layer 33 and in the surface of the other bipolar plate 31 that is brought into contact with the cathode catalyst layer 34. The grooves on the anode side are supplied with a methanol solution, which is a fuel, and the grooves on the cathode side are supplied with air. When a hydrogen gas is supplied as a fuel instead of the methanol solution in FIG. 3, an example of the inventive PEFC is implemented.

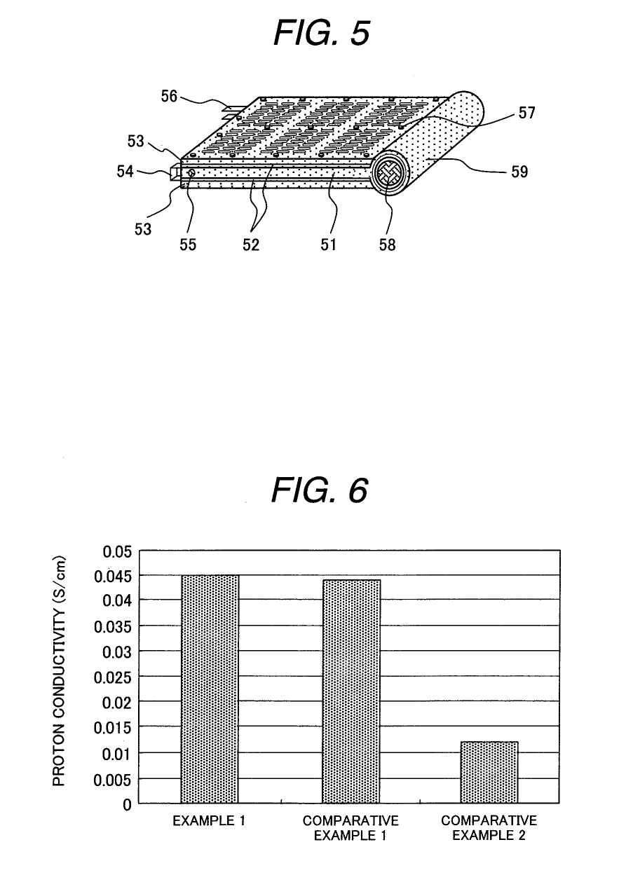

A direct methanol fuel cell for a mobile unit can be configured by using the MEA including the inventive composite electrolyte membrane comprising organic macromolecules and metal-oxide hydrate having proton conductivity. FIGS. 4 and 5 show an example of a direct methanol fuel cell designed for personal digital assistants (PDAs). FIG. 4 is a schematic illustration showing an exploded view of the direct methanol fuel cell; an anode end plate 42, a gasket 43, diffusion layer-equipped MEA 44, another gasket 43, and a cathode end plate 45 are laminated in that order on each surface of a fuel chamber 41 with a cartridge holder 47. The two laminates are combined and fixed with screws 48 so that a pressure applied within the stacks is approximately uniformed. A terminal 46 is led from each of the anode end plate 42 and cathode end plate 45 so that electric power can be delivered. FIG. 5 is a schematic illustration showing a perspective view of the direct methanol fuel cell in FIG. 4 according to the present invention. A plurality of MEAs (12 MEAs in FIG. 5) are connected in series on two sides of a fuel chamber 51. The MEAs connected in series on the two sides are further connected in series through a connection terminal 54 so that electric power can be delivered from an output terminal 56. In FIG. 5, a methanol solution is pressurized by a high-pressure liquefied gas or high-pressure gas from a fuel cartridge 58 or a spring, and the pressurized methanol solution is supplied. A carbon dioxide gas generated at the anode is exhausted from a gas exhaust port 55. The gas exhaust port 55 has a gas-liquid separating function, so it passes a gas but does not pass a liquid. Air used as an oxidizer is supplied by being diffused through an air diffusion slit in the cathode end plate 53; water generated at the cathode is exhausted by being diffused through the slit. The method of integrating the laminates is not limited to the tightening of them with screws 57; the laminates may be inserted into a case and integrated by compressing forces in the case.

The present invention will be described below in detail by using examples. However, the present invention is not limited to these examples described herein.

### Example 1

Zirconium oxide hydrate ZrO₂.nH₂O was used as the metal-oxide hydrate, and sulfonated-poly ether sulfone (S-PES) in which the sulfonic acid group was included in polyethersulfone was used as the solid-state organic macromolecule and intermediate layer. The ion exchange capacity per unit dry weight was 0.91 meq/g for the solid-state organic macromolecule and 1.4 meq/g for the intermediate layer. The precursor dispersion method was applied as the preparation method of the composite electrolyte membrane; zirconium oxychloride ZrOCl₂.8H₂O was used as the precursor of zirconium oxide hydrate ZrO₂.nH₂O.

Firstly, precursor varnish in which ZrOCl₂.8H₂O was dissolved in dimethyl sulfoxide was prepared. The concentration of the solute (ZrOCl₂.8H₂O) was 30 wt %. Another varnish in which S-PES (with an ion exchange capacity of 1.4 meq/g) was dissolved in dimethyl sulfoxide was also prepared. The concentration of the solute (S-PES) was 30 wt %. These two types of varnish were mixed and stirred with a stirrer for 30 minutes. The resulting mixture was then dried by a vacuum dryer at 80° C. for three hours so as to evaporate the dimethyl sulfoxide solvent, resulting in ZrOCl₂.8H₂O coated with S-PES (with an ion exchange capacity of 1.4 meq/g).

This ZrOCl₂.8H₂O was mixed with varnish (with a solute concentration of 30 wt %) in which S-PES (with an ion exchange capacity of 0.91 meq/g) was dissolved in dimethylsulfoxide, and then was stirred with the stirrer for two hours. After that, the resulting mixture was applied to a glass plate by using an applicator and then was dried by the vacuum dryer at 80° C. for three hours so as to evaporate the dimethylsulfoxide solvent. The applied membrane was then removed from the glass plate and was dipped in a 25 wt % NH₃ water to promote a chemical reaction described below in the membrane.

ZrOCl₂.8H₂O+(n+1)H₂O-->ZrO₂.nH₂O+2H⁺2Cl⁻

The membrane was then dipped in a 0.5M KOH solution to remove Cl⁻ and was washed with pure water. The membrane was finally dipped in a 1M H₂SO₄ solution for protonation, resulting in S-PES (with an ion exchange capacity of 0.91 meq/g) in which ZrO₂.nH₂O was dispersed. The content of ZrO₂.nH₂O was 50 wt %. The entire electrolyte membrane prepared was uniformly white. Its thickness was adjusted to 50 μm.

The proton conductivity of the composite electrolyte membrane prepared as described above was measured at a temperature of 70° C. and a relative humidity of 95%.

In order to measure the amount of methanol that penetrated through the prepared composite electrolyte membrane, an MEA including the composite electrolyte membrane was formed and an electrochemical method was used. A voltage was applied to the methanol that penetrated from the anode to the cathode so as to electrochemically oxidize the methanol. A current that flowed at that time was measured as a methanol penetration current. Specifically, a current that flowed when a fixed voltage of 0.8 V was applied was measured by a method described in J. Electrochem. Soc., 147 (2) 466 (2000).

The MEA was prepared as described below. Platinum-supporting carbon TEC10V50E (the platinum content of 50 wt %) from Tanaka Kikinzoku Kogyo K.K. was used as the cathode catalyst, and platinum-ruthenium-supporting carbon TEC61V54 (the platinum content of 29 wt % and the ruthenium content of 23 wt %) from Tanaka Kikinzoku Kogyo K.K. was used as the anode catalyst. Water and a 5 wt % Nafion (registered trademark) solution from Sigma-Aldrich Japan K.K. were added to these catalysts. The resulting mixture was stirred to prepare catalyst slurry. For the cathode, the weight ratio of TEC10V50E, the water, and the 5 wt % Nafion solution in the catalyst slurry was 1:1:8.46; for the anode, the weight ratio of TEC61V54, the water, and the 5 wt % Nafion solution in the catalyst slurry was 1:1:7.9. These catalyst slurries were applied to polytetrafluoroethylene sheets by using an applicator so as to prepare a cathode catalyst layer and anode catalyst layer. The cathode catalyst layer and anode catalyst layer were then thermally attached to the composite electrolyte membrane of this example by hot-pressing to prepare an MEA. The content of Pt and Ru in the anode catalyst was 1.8 mg/cm², and the amount of Pt in the cathode catalyst was 1.2 mg/cm².

The cathode catalyst layer of the prepared MEA was used as an action pole, and the anode catalyst layer was used as the opposite pole. A nitrogen gas was flowed to the action pole at a flow rate of 100 ml/min, and the opposite pole side was filled with a methanol solution with a concentration of 5 wt %. A voltage of 0.1 to 0.8 V was applied across the action pole and opposite pole to oxidize the methanol that penetrated to the action pole. A current that flowed at that time was measured as a methanol penetration current.

The I-V characteristics of the MEA used in the measurement of the amount of methanol penetration were measured. The cell shown in FIG. 3 was used as a measurement cell. Air was supplied to the cathode through natural aspiration, and a methanol solution was supplied to the anode at a flow rate of 10 ml/min. The concentration of the methanol solution was 20 wt %. The I-V characteristics measurement was carried out at a temperature of 25° C. with the measurement cell.

### Comparative Example 1

Zirconium oxide hydrate ZrO₂.nH₂O was used as the metal-oxide hydrate, and sulfonated-poly ether sulfone (S-PES) in which the sulfonic acid group was included in polyethersulfone was used as the solid-state organic macromolecule. In Comparative example 1, the intermediate layer was not formed. The ion exchange capacity per unit dry weight was 0.91 meq/g. The precursor dispersion method was used as the preparation method of the composite electrolyte membrane; zirconium oxychloride ZrOCl₂.8H₂O was used as the precursor of zirconium oxide hydrate ZrO₂.nH₂O. As described above, Comparative example 1 was the same as Example 1 except the intermediate layer.

The proton conductivity of the obtained composite electrolyte membrane in Comparative example 1 was measured under the same conditions as in Example 1. Furthermore, the obtained electrolyte membrane was used to prepare an MEA by the same method and under the same condition as in Example 1, and the amount of methanol permeation was measured. The MEA was also used to measure the I-V characteristics under the same conditions as in Example 1.

### Comparative Example 2

S-PES (with an ion exchange capacity of 0.91 meq/g) was used as the electrolyte membrane. Varnish in which S-PES (with an ion exchange capacity of 0.91 meq/g) was dissolved in dimethylsulfoxide was prepared. The concentration of the solute was 30 wt %. The varnish was applied to a glass plate with an applicator and then dried by a vacuum dryer at 80° C. for three hours so as to evaporate the dimethylsulfoxide solvent. The applied membrane was then removed from the glass plate and dipped in a 1M H₂SO₄ solution over one night for protonation, resulting in an electrolyte membrane comprising only S-PES (with an ion exchange capacity of 0.91 meq/g). The obtained electrolyte membrane was transparent. The thickness of the electrolyte membrane was adjusted to 50 μm.

The proton conductivity of the obtained electrolyte membrane in Comparative example 2 was measured under the same conditions as in Example 1. Furthermore, the obtained electrolyte membrane was used to prepare an MEA by the same method and under the same condition as in Example 1, and the amount of methanol permeation was measured. The MEA was also used to measure the I-V characteristics under the same conditions as in Example 1.

FIG. 6 is a graph showing the proton conductivities of the electrolyte membranes in Example 1 according to the present invention, Comparative example 1, and Comparative example 2. The measurement of the proton conductivities was carried out under a relative humidity of 95%. As shown in FIG. 6, the proton conductivity of the electrolyte membrane comprising only S-PES (with an ion exchange capacity of 0.91 meq/g) in Comparative example 2 was 0.012 S/cm. By comparison, that of the electrolyte membrane comprising S-PES (with an ion exchange capacity of 0.91 meq/g), in Comparative example 1, in which ZrO₂.nH₂O was dispersed was 0.044 S/cm, indicating a more than three-fold increase. For S-PES (with an ion exchange capacity of 0.91 meq/g), in Example 1, in which ZrO₂.nH₂O coated with the intermediate layer was dispersed, the proton conductivity was 0.045 S/cm, which was almost the same value in Comparative example 1.

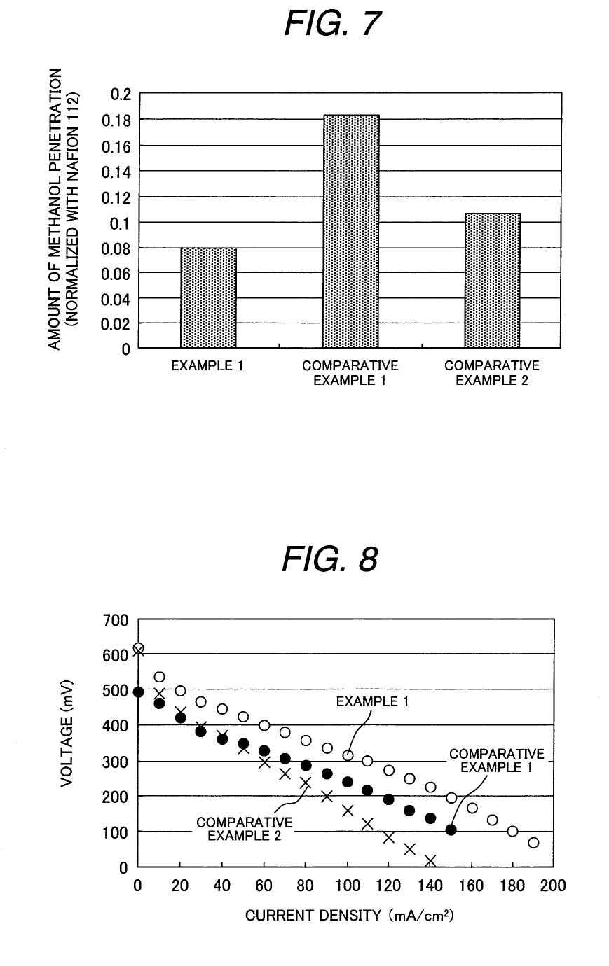

FIG. 7 is a graph showing the amounts of methanol penetration of MEAs using the electrolyte membranes in Example 1, Comparative example 1, and Comparative example 2. The vertical axis is normalized, assuming that the current density is “1” when methanol penetrates through the Nafion 112. When S-PES (with an ion exchange capacity of 0.91 meq/g), in Comparative example 1, was used in which ZrO₂.nH₂O was dispersed, the amount of methanol penetration increased, as compared with the electrolyte membrane comprising only S-PES (with an ion exchange capacity of 0.91 meq/g) in Comparative example 2. A probable reason for this increase is that the adhesion between ZrO₂.nH₂O and S-PES is low in Comparative example 1 and thereby methanol penetrates along the interface therebetween. On the contrary, for S-PES (with an ion exchange capacity of 0.91 meq/g), in Example 1, in which ZrO₂.nH₂O coated with the intermediate layer was dispersed, the amount of methanol permeation decreased greatly, as compared with Comparative example 1. A probable reason for this reduction is that the coated intermediate layer improves the adhesion at the interface between ZrO₂.nH₂O and S-PES. The amount of methanol penetration in Example 1 is also lower than that in Comparative example 2 in which the electrolyte membrane comprises only S-PES. This indicates that the penetration of methanol is blocked by ZrO₂.nH₂O.

Summarizing above results, the proton conductivity greatly increased in Example 1 and Comparative example 1, in which ZrO₂.nH₂O was dispersed in S-PES (with an ion exchange capacity of 0.91 meq/g), as compared with Comparative example 2 in which the electrolyte membrane comprises only S-PES (with an ion exchange capacity of 0.91 meq/g). The amount of methanol penetration increased in Comparative example 1, but could be reduced in Example 1. This strongly suggests that because an intermediate layer was applied, ZrO₂.nH₂O functioned effectively in increasing the proton conductivity and blocking the penetration of methanol, as originally predicted, and that Example 1 eliminated the tradeoff between the proton conductivity and the amount of methanol penetration as seen in the electrolyte membrane comprising only S-PES.

FIG. 8 is a graph showing the I-V characteristics of MEAs using the electrolyte membranes in Example 1, Comparative example 1, and Comparative example 2. The open circuit voltage (OCV) was 617 mV in Example 1, 493 mV in Comparative example 1, and 610 mV in Comparative example 2. As the reason why the OCV was low in Comparative example 1, it can be considered that the amount of methanol penetration is large. The voltage in Example 1 was higher than those in Comparative example 1 and Comparative example 2, delivering high output power. A maximum output of 33 mW/cm² was obtained when the current density was 120 mA/cm² in Example 1. For the composite electrolyte membrane in Comparative example 1, a maximum output of 24 mW/cm² was obtained when the current density was 100 mA/cm². For the electrolyte membrane comprising only S-PES (with an ion exchange capacity of 0.91 meq/g) in Comparative example 2, a maximum output of 19 mW/cm² was obtained when the current density was 80 mA/cm². In Example 1, the voltage increased by an amount of which a methanol crossover was reduced, as compared with the composite electrolyte membrane in Comparative example 1. On the other hand, for the electrolyte membrane comprising only S-PES (with an ion exchange capacity of 0.91 meq/g) in Comparative example 2, the voltage was relatively high in a low current density region by an amount of which a methanol crossover was relatively small, as compared with the composite electrolyte membrane in Comparative example 1. However, in a high current density region, since the proton conductivity is low, a voltage drop occurred due to an IR drop caused by a membrane resistance.

### Example 2

Zirconium oxide hydrate ZrO₂.nH₂O was used as the metal-oxide hydrate, and sulfonated-poly ether sulfone (S-PES) in which the sulfonic acid group was included in polyethersulfone was used as the solid-state organic macromolecule and intermediate layer. The ion exchange capacity per unit dry weight was 0.91 meq/g for the solid-state organic macromolecule and 1.4 meq/g for the intermediate layer. In Example 2, the content of ZrO₂.nH₂O was changed, i.e., 10 and 30 wt % were selected. The preparation method of the composite electrolyte membrane was the same as in Example 1. The membrane was transparent at 10 wt % and translucent at 30 wt %.

The proton conductivity was measured under the same conditions as in Example 1. An MEA was prepared by the same method and under the same condition as in Example 1, and the MEA was used to measure the amount of methanol penetration and I-V characteristics.

### Comparative Example 3

Zirconium oxide hydrate ZrO₂.nH₂O was used as the metal-oxide hydrate, and sulfonated-poly ether sulfone (S-PES) in which the sulfonic acid group was included in polyethersulfone was used as the solid-state organic macromolecule. In Comparative example 3, the intermediate layer was not formed, and the content of ZrO₂.nH₂O was changed, i.e., 10 and 30 wt % were selected. The preparation method of the composite electrolyte membrane except the intermediate layer was the same as in Example 1. The membrane was transparent at 10 wt % and translucent at 30 wt %.

The proton conductivity was measured under the same conditions as in Example 1. An MEA was prepared by the same method and under the same condition as in Example 1, and the MEA was used to measure the amount of methanol penetration and I-V characteristics.

Table 1 indicates the proton conductivity in Example 2 and Comparative example 3. For comparison purposes, Table 1 also indicates the proton conductivity measured in Example 1 and Comparative example 1 in which the content of ZrO₂.nH₂O is 50 wt % as well as the proton conductivity of the electrolyte membrane comprising only S-PES in Comparative example 2. When the content of ZrO₂.nH₂O is 10 wt %, there is almost no effect of ZrO₂.nH₂O dispersion in Example 2 and Comparative example 3, and the proton conductivity is almost the same as that of the electrolyte membrane comprising only S-PES in Comparative example 2. When the content of ZrO₂.nH₂O is 30 wt %, the proton conductivity in Example 2 and Comparative example 3 is almost twice that of the electrolyte membrane comprising only S-PES in Comparative example 2.

[Table 1]

TABLE 1

| | | | | | 0 wt % |
|---|---|---|---|---|---|
| Content of ZrO₂•nH₂O | | 10 wt % | 30 wt % | 50 wt % | (S-PES) |
| With | Example 2 | 0.012 S/cm | 0.023 S/cm | 0.045 S/cm | 0.012 S/cm |
| intermediate | | | | (Example 1) | (Comparative |
| layer | | | | | example 2) |
| Without | Comparative | 0.012 S/cm | 0.02 S/cm | 0.044 S/cm | |
| intermediate | example 3 | | | (Comparative | |
| layer | | | | example 1) | |

Table 2 indicates the amount of methanol penetration (normalized) in Example 2 and Comparative example 3, assuming that the current density is “1” when methanol penetrates through the Nafion 112 (Nafion: registered trademark). For comparison purposes, Table 2 also indicates the amount of methanol permeation measured in Example 1 and Comparative example 1 in which the content of ZrO₂.nH₂O is 50 wt % as well as the methanol permeation of the electrolyte membrane comprising only S-PES in Comparative example 2. In the comparative examples in which there is no intermediate layer, the amount of methanol penetration increases with increasing the content of ZrO₂.nH₂O. On the contrary, the amount of methanol that permeates through the composite electrolyte membrane in the examples in which an intermediate layer is formed is smaller than that through the electrolyte membrane comprising only S-PES. In addition, the amount of methanol permeation decreases with increasing the content of ZrO₂.nH₂O. It can be considered that ZrO₂.nH₂O blocks methanol permeation.

[Table 2]

TABLE 2

| Content of ZrO₂•nH₂O | | 10 wt % | 30 wt % | 50 wt % | 0 wt % (S-PES) |
|---|---|---|---|---|---|
| With intermediate | Example 2 | 0.096 | 0.091 | 0.081 | 0.11 |
| layer | | | | (Example 1) | (Comparative |
| Without | Comparative | 0.097 | 0.15 | 0.18 | example 2) |
| intermediate | example 3 | | | (Comparative | |
| layer | | | | example 1) | |

Table 3 indicates the maximum output density in Example 2 and Comparative example 3. For comparison purposes, Table 3 also indicates the maximum output density measured in Example 1 and Comparative example 1 in which the content of ZrO₂.nH₂O is 50 wt % as well as the maximum output density for the electrolyte membrane comprising only S-PES in Comparative example 2. In both the examples with an intermediate layer and the comparative examples without an intermediate layer, the output density increases with increasing the content of ZrO₂.nH₂O. In the examples in which there is an intermediate layer, however, the amount of methanol penetration is small, a large output density could be obtained, as compared with the comparative examples in which there is no intermediate layer.

[Table 3]

TABLE 3

| | | | | | 0 wt % |
|---|---|---|---|---|---|
| Content of ZrO₂•nH₂O | | 10 wt % | 30 wt % | 50 wt % | (S-PES) |
| With | Example 2 | 19 mW/cm² | 26 mW/cm² | 33 mW/cm² | 19 mW/cm² |
| intermediate | | | | (Example 1) | (Comparative |
| layer | | | | | example 2) |
| Without | Comparative | 18 mW/cm² | 22 mW/cm² | 24 mW/cm² | |
| intermediate | example 3 | | | (Comparative | |
| layer | | | | example 1) | |

### Example 3

Zirconium oxide hydrate ZrO₂.nH₂O was used as the metal-oxide hydrate, and sulfonated-poly ether sulfone (S-PES) in which the sulfonic acid group was included in polyethersulfone was used as the solid-state organic macromolecule and intermediate layer. The ion exchange capacity per unit dry weight was 0.91 meq/g for the solid-state organic macromolecule and 1.4 meq/g for the intermediate layer.

The simple dispersion method was used as the preparation method of the composite electrolyte membrane. ZrO₂.nH₂O was synthesized as described below. Firstly, 16.1 grams (0.05 mol) of zirconium oxychloride ZrOCl₂.8H₂O was dissolved in 50 ml of water, and 10 ml of 25 wt % NH₃ solution was added to promote hydrolysis reaction indicated by the chemical formula shown below.

ZrOCl₂.8H₂O+(n+1)H₂O-->ZrO₂.nH₂O+2H⁺+2Cl⁻

The precipitation was separated by filtration and was washed with a 0.5M KOH solution to remove Cl⁻. The precipitation was further washed with pure water and was dried in a desiccator, producing a white powder of ZrO₂.nH₂O.

Varnish in which S-PES (with an ion exchange capacity of 1.4 meq/g) was dissolved in dimethylsulfoxide was prepared. The concentration of the solute (S-PES) was 30 wt %. The white powder of ZrO₂.nH₂O was added to the varnish and the resulting mixture was stirred with a stirrer for 30 minutes. The stirred mixture was then dried by a vacuum dryer at 80° C. for three hours so as to evaporate the dimethylsulfoxide solvent, resulting in ZrO₂.nH₂O powder coated with S-PES (with an ion exchange capacity of 1.4 meq/g).

Another varnish in which S-PES (with an ion exchange capacity of 0.91 meq/g) was dissolved in dimethylsulfoxide was also prepared. The concentration of the solute (S-PES) was 30 wt %. Coated ZrO₂.nH₂O was added to the varnish and the resulting mixture was stirred with the stirrer for two hours. After that, the varnish was applied to a glass plate by using an applicator and then was dried by the vacuum dryer at 80° C. for three hours so as to evaporate the dimethylsulfoxide solvent, forming a membrane. The membrane was dipped in a 1M H₂SO₄ solution over one night for protonation, producing S-PES (with an ion exchange capacity of 0.91 meq/g) in which ZrO₂.nH₂O was dispersed. The content of ZrO₂.nH₂O was 50 wt %.

The proton conductivity was measured for membranes, which were formed as described above, under the same conditions as in Example 1. Furthermore, MEAs in which these membranes were used were prepared by the same method and under the same conditions as in Example 1. These MEAs were used to measure the amount of methanol permeation and I-V characteristics.

The measurement result of the proton conductivity was 0.04 S/cm². This value is slightly smaller than the proton conductivity of the composite electrolyte membrane synthesized by the precursor dispersion method in Example 1. As a reason for this, it can be considered that dispersion of ZrO₂.nH₂O was not performed completely. The amount of methanol permeation was 0.10, which was normalized in which the current density is assumed to be “1” when methanol penetrates through the Nafion 112. This value is slightly larger than the amount of methanol that penetrated through the electrolyte membrane synthesized by the precursor dispersion method in Example 1. As a reason for this, it can be also considered that dispersion of ZrO₂.nH₂O was not performed completely when compared with Example 1, methanol penetrated through clearances among aggregated ZrO₂.nH₂O, and thereby the amount of methanol penetration slightly increased. On the other hand, the output density was 29 mW/cm².

### Comparative Example 4

Zirconium oxide hydrate ZrO₂.nH₂O was used as the metal-oxide hydrate, and sulfonated-poly ether sulfone (S-PES) in which the sulfonic acid group was included in polyethersulfone was used as the solid-state organic macromolecule. The ion exchange capacity per unit dry weight was 0.91 meq/g. In Comparative example 4, the intermediate layer was not formed. The preparation method of the composite electrolyte membrane except the intermediate layer was the same as in Example 3; specifically the simple dispersion method was used. The content of ZrO₂.nH₂O was 50 wt %.

The proton conductivity was measured for membranes, which were formed as described above, under the same conditions as in Example 1. Furthermore, MEAs in which these membranes were used were prepared by the same method and under the same conditions as in Example 1. These MEAs were used to measure the amount of methanol penetration and I-V characteristics.

The measurement result of the proton conductivity was 0.038 S/cm². The amount of methanol penetration was 0.30, which was normalized in which the current density is assumed to be “1” when methanol permeates through the Nafion 112. This value is greatly large, as compared with the composite electrolyte membrane in which the intermediate layer is formed by using the simple dispersion method in Example 3. As a reason for this, it can be considered that since the adhesion on the interface between ZrO₂.nH₂O and S-PES in Comparative example 4 was low due to the lack of the intermediate layer and aggregation of ZrO₂.nH₂O was formed due to poor dispersion of ZrO₂.nH₂O, methanol permeated easily through clearances that were thus formed among ZrO₂.nH₂O particles. On the other hand, the output density was 10 mW/cm².

### Example 4

Tin oxide hydrate SnO₂.2H₂O was used as the metal-oxide hydrate, and sulfonated-poly ether sulfone (S-PES) in which the sulfonic acid group was included in polyethersulfone was used as the solid-state organic macromolecule and intermediate layer. The ion exchange capacity per unit dry weight was 0.91 meq/g for the solid-state organic macromolecule and 1.4 meq/g for the intermediate layer. The precursor dispersion method was used as the preparation method of the composite electrolyte membrane; SnCl₄.5H₂O was used as the precursor of tin oxide hydrate SnO₂.2H₂O.

Firstly, precursor varnish in which SnCl₄.5H₂O was dissolved in dimethylacetamide was prepared. The concentration of the solute (SnCl₄.5H₂O) was 30 wt %. Another varnish in which S-PES (with an ion exchange capacity of 1.4 meq/g) was dissolved in dimethylacetamid was also prepared. The concentration of the solute (S-PES) was 30 wt %. These two types of varnish were mixed and stirred with a stirrer for 30 minutes. The resulting mixture was then dried by a vacuum dryer so as to evaporate the dimethylacetamid solvent, resulting in SnCl₄.5H₂O coated with S-PES (with an ion exchange capacity of 1.4 meq/g).

This SnCl₄.5H₂O was mixed with varnish (with a solute concentration of 30 wt %) in which S-PES (with an ion exchange capacity of 0.91 meq/g) was dissolved in dimethylacetamid, and then was stirred with the stirrer for two hours. After that, the resulting varnish was applied to a glass plate with an applicator and then was dried by the vacuum dryer at 80° C. for three hours so as to evaporate the dimethylacetamid solvent. The applied membrane was then removed from the glass plate and was dipped in a 25 wt % NH₃ water to promote a chemical reaction described below in the membrane.

SnCl₄.5H₂O-->SnO₂.2H₂O+4H⁺+4Cl⁻+H₂O

The membrane was then dipped in a 0.5M KOH solution to remove Cl⁻ and was washed with pure water. The membrane was finally dipped in a 1M H₂SO₄ solution for protonation, resulting in S-PES (with an ion exchange capacity of 0.91 meq/g) in which SnO₂.2H₂O was dispersed. The content of SnO₂.2H₂O was 50 wt %. The prepared electrolyte membrane was white.

The proton conductivity of the composite electrolyte membrane prepared as described above was measured under the same conditions as in Example 1. Furthermore, an MEA including this membrane was prepared by the same method and under the same conditions as in Example 1. The MEA was used to measure the amount of methanol penetration and I-V characteristics. As a result, the proton conductivity was 0.033 S/cm at a temperature of 70° C. and a relative humidity of 95%, indicating an about 2.5 fold improvement as compared with the electrolyte membrane comprising only S-PES (with an ion exchange capacity of 0.91 meq/g) in Comparative example 2. Assuming that the current density is “1” when methanol penetrates through the Nafion 112, the normalized amount of methanol penetration was 0.1, which was almost the same as that in Comparative example 2. Accordingly, above results that the amount of methanol permeation was almost the same and the proton conductivity was doubled, as compared with the results in Comparative example 2, indicates that the tradeoff between the proton conductivity and the amount of methanol permeation was dissolved. On the other hand, the maximum output was 28 mW/cm².

### Comparative Example 5

Tin oxide hydrate SnO₂.2H₂O was used as the metal-oxide hydrate, and sulfonated-poly ether sulfone (S-PES) in which the sulfonic acid group was included in polyethersulfone was used as the solid-state organic macromolecule. In Comparative example 5, the intermediate layer was not formed. The ion exchange capacity per unit dry weight was 0.91 meq/g. The precursor dispersion method was used as the preparation method of the composite electrolyte membrane; SnCl₄.5H₂O was used as the precursor of tin oxide hydrate SnO₂.2H₂O. As described above, Comparative example 5 was the same as Example 1 except the process of forming the intermediate layer. The proton conductivity of the obtained electrolyte membrane was measured under the same conditions as in Example 4. The electrolyte membrane was used to prepare an MEA by the same method and under the same condition as in Example 1. The MEA was used to measure the amount of methanol penetration and the I-V characteristics.

The measurement result of the proton conductivity was 0.03 S/cm², which is almost the same as in Example 4. However, the amount of methanol penetration largely increased to 0.2. As a reason for this, it can be considered that since the adhesion on the interface between S-PES and SnO₂.2H₂O was low due to the lack of the intermediate layer, methanol penetrated through clearances that were thus formed at the interface. On the other hand, the maximum output was 20 mW/cm².

### Example 5

Tungstic oxide dihydrate WO₃.2H₂O was used as the metal-oxide hydrate, and sulfonated-poly ether sulfone (S-PES) in which the sulfonic acid group was included in polyethersulfone was used as the solid-state organic macromolecule and intermediate layer. The ion exchange capacity per unit dry weight was 0.91 meq/g for the solid-state organic macromolecule and 1.4 meq/g for the intermediate layer. A composite electrolyte membrane was prepared by the simple dispersion method.

WO₃.2H₂O was synthesized as described below. A 50 ml of 1.0M Na₂WO₃ solution was gradually dripped to 450 ml of a 3-N HCl that was cooled to 5° C. while HCl was being stirred with a stirrer. Thereby, a yellow precipitation was obtained. After clear supernatant liquid was removed, 300 ml of 0.1N HCl was added and stirred for 10 minutes, and the resulting mixture was then left so that the precipitation was settled, after which clear supernatant liquid was removed. Then, 300 ml of pure water was added to the precipitation, stirred for 10 minutes, and left for 24 hours. After particles were settled and completely separated from the solution, clear supernatant liquid was removed from the solution. The same amount of pure water was then added. This cleaning operation was repeated six times to remove impurity ions derived from unreacted raw material. Filtration was finally performed and WO₃.2H₂O of a yellow powder was obtained.

Varnish in which S-PES (with an ion exchange capacity of 1.4 meq/g) was dissolved in dimethylacetamid was also prepared. WO₃.2H₂O was added to the varnish and was stirred with a stirrer for 30 minutes. The resulting mixture was then dried by a vacuum dryer for three hours at 80° C. so as to evaporate the dimethylacetamid solvent, resulting in WO₃.2H₂O powder coated with S-PES (with an ion exchange capacity of 1.4 meq/g).

This WO₃.2H₂O was mixed with varnish (with a dissolved substance concentration of 30 wt %) in which S-PES (with an ion exchange capacity of 0.91 meq/g) was dissolved in dimethylacetamid, and then was stirred by using the stirrer for two hours. After that, the resulting mixture was applied to a glass plate with an applicator and then was dried by the vacuum dryer at 80° C. for three hours so as to evaporate the dimethylacetamid solvent, producing an electrolyte membrane.

The obtained electrolyte membrane was entirely corn-colored, but yellow grains were also found in some places.

The proton conductivity of the obtained electrolyte membrane was measured under the same conditions as in Example 1. Furthermore, the electrolyte membrane was used to prepare an MEA by the same method and under the same condition as in Example 1. The MEA was used to measure the amount of methanol permeation and the I-V characteristics.

The proton conductivity was 0.025 S/cm at a temperature of 70° C. and a relative humidity of 95%, indicating an about two-fold improvement as compared with the electrolyte membrane comprising only S-PES (with an ion exchange capacity of 0.91 meq/g) in Comparative example 2. Assuming that the current density is “1” when methanol penetrates through the Nafion 112, the normalized amount of methanol permeation was 0.11. Although the amount of methanol penetration slightly increased due to aggregation of WO₃.2H₂O, it can be said that the amount is almost the same as when the electrolyte membrane comprising only S-PES is used. Accordingly, above results that proton conductivity was doubled indicates that the tradeoff between the proton conductivity and the amount of methanol penetration was dissolved. On the other hand, the maximum output was 24 mW/cm².

### Comparative Example 6

Tungstic oxide dihydrate WO₃.2H₂O was used as the metal-oxide hydrate, and sulfonated-poly ether sulfone (S-PES) in which the sulfonic acid group was included in polyethersulfone was used as the solid-state organic macromolecule. In Comparative example 6, the intermediate layer was not formed. The ion exchange capacity per unit dry weight was 0.91 meq/g. The simple dispersion method was used as the preparation method of the composite electrolyte membrane. Comparative example 6 was the same as Example 1 except the process of forming the intermediate layer.

The proton conductivity of the obtained electrolyte membrane was measured under the same conditions as in Example 1. Furthermore, the electrolyte membrane was used to prepare an MEA by the same method and under the same condition as in Example 1. The MEA was used to measure the amount of methanol permeation and I-V characteristics.

The measurement result of the proton conductivity was 0.023 S/cm, which is almost the same as in Example 5. However, the normalized amount of methanol penetration largely increased to 0.25. As a reason for this, it can be considered that since the adhesion on the interface between S-PES and WO₃.2H₂O was low due to the lack of the intermediate layer, methanol permeated through clearances that were thus formed at the interface. On the other hand, the maximum output was 19 mW/cm².

### Example 6

Zirconium oxide hydrate ZrO₂.nH₂O was used as the metal-oxide hydrate, and sulfonated-poly ether sulfone (S-PES) in which the sulfonic acid group was included in polyethersulfone was used as the solid-state organic macromolecule and intermediate layer. The ion exchange capacity per unit dry weight was 0.91 meq/g for the solid-state organic macromolecule and 1.4 meq/g for the intermediate layer. A composite electrolyte membrane was prepared by the same method and under the same condition as in Example 1. The content of ZrO₂.nH₂O was 50 wt %. Furthermore, this composite electrolyte membrane was used to prepare an MEA by the same method and under the same condition as in Example 1. The dimensions of the catalyst layer of the MEA were 24 mm×27 mm. The MEA was assembled in the DMFC for a PDA, as shown in FIG. 5. A 10 wt % methanol solution was used as a fuel. In an output power measurement of DMFC, a maximum output was 2.2 W at room temperature.

### Comparative Example 7

Zirconium oxide hydrate ZrO₂.nH₂O was used as the metal-oxide hydrate, and sulfonated-poly ether sulfone (S-PES) in which the sulfonic acid group was included in polyethersulfone was used as the solid-state organic macromolecule. The ion exchange capacity per unit dry weight was 0.91 meq/g for the solid-state organic macromolecule. In Comparative example 7, the intermediate layer was not formed. An MEA was prepared by the same method and under the same condition as in Example 1. The dimensions of the catalyst layer of the MEA were 24 mm×27 mm. The MEA was assembled in the DMFC for a PDA, as shown in FIG. 5. A 10 wt % methanol solution was used as a fuel. In the output power measurement of DMFC, a maximum output was 1.0 W at room temperature. It can be considered that the output decreased by an amount of which the amount of methanol penetration (methanol crossover) increased, as compared with Example 6.

### Example 7

The inventive composite electrolyte membrane comprising metal-oxide hydrate and organic macromolecules, and having high adhesion therebetween was used in a PEFC. Zirconium oxide hydrate ZrO₂.nH₂O was used as the metal-oxide hydrate, and sulfonated-poly ether sulfone (S-PES) was used as the solid-state organic macromolecule and intermediate layer. The ion exchange capacity per unit dry weight was 0.91 meq/g for the solid-state organic macromolecule and 1.4 meq/g for the intermediate layer. A composite electrolyte membrane was prepared by the same method and under the same condition as in Example 1. The content of ZrO₂.nH₂O was 50 wt %.

This composite electrolyte membrane was used to prepare an MEA for PEFCs as described below. Platinum-supporting carbon TEC10V50E (the platinum content of 50 wt %) from Tanaka Kikinzoku Kogyo K.K. was used as the cathode catalyst and anode catalyst. Water and a 5 wt % Nafion (registered trademark) solution from Sigma-Aldrich Japan K.K. were added to these catalysts. The resulting mixture was stirred to prepare catalyst slurry. For both the cathode and anode, the weight ratio of TEC10V50E, the water, and the 5 wt % Nafion solution in the catalyst slurry was 1:1:8.46. The catalyst slurry was applied to polytetrafluoroethylene sheets by using an applicator so as to prepare a cathode catalyst layer and anode catalyst layer. The cathode catalyst layer and anode catalyst layer were then thermally attached to the composite electrolyte membrane according to the present invention by hot-pressing to prepare an MEA. For both the anode catalyst and cathode catalyst, the amount of Pt was 0.3 mg/cm². The areas of the catalyst layers were each 3 cm×3 cm.

The prepared MEA was assembled in the measurement cell shown in FIG. 3. As reaction gases, hydrogen was used for the anode and air was used for the cathode. In order to humidify both gases, the gases were supplied through water at 90° C. by using a water bubbler under one-atmospheric pressure. The humidified gases were supplied to the measurement cell. The gas flow rate of hydrogen was 50 ml/min, and the gas flow rate of air was 200 ml/min. The cell temperature was 110° C.

In a measurement of the I-V characteristics of PEFCs, the cell voltage of 580 mV was exhibited at a current density of 500 mA/cm².

### Comparative Example 8

Zirconium oxide hydrate ZrO₂.nH₂O was used as the metal-oxide hydrate, and sulfonated-poly ether sulfone (S-PES) in which the sulfonic acid group was included in polyethersulfone was used as the solid-state organic macromolecule. The ion exchange capacity per unit dry weight was 0.91 meq/g for the solid-state organic macromolecule. In Comparative example 8, the intermediate layer was not formed. This composite electrolyte membrane was used to prepare an MEA for PEFCs by the same method and under the same conditions as in Example 7. The output of the fuel cell shown in FIG. 3, in which the MEA in Comparative example 8 was assembled, was measured under the same measurement conditions as in Example 7.

As a result, the cell voltage of 500 mV was obtained at a current density of 500 mA/cm². It can be considered that since the adhesion on the interface between the zirconium oxide hydrate ZrO₂.nH₂O and S-PES was low, some amount of hydrogen gas or air leaked through clearances, which were thereby formed, and the voltage was lower than that measured in Example 7.

### Comparative Example 9

S-PES (with an ion exchange capacity of 0.91 meq/g) was used as the solid-state electrolyte membrane. Varnish in which this S-PES (with an ion exchange capacity of 0.91 meq/g) was dissolved in dimethylsulfoxide was prepared. Its solute concentration was 30 wt %. The varnish was applied to a glass plate with an applicator and then was dried by a vacuum dryer at 80° C. for three hours so as to evaporate the dimethylsulfoxide solvent. The applied membrane was then removed from the glass plate and was dipped in a 1M H₂SO₄ solution over one night for protonation, producing an electrolyte membrane comprising only S-PES (with an ion exchange capacity of 0.91 meq/g). The produced electrolyte membrane was transparent and had a thickness of 50 μm.

This electrolyte membrane was used to prepare an MEA for PEFCs by the same method and under the same conditions as in Example 7. The output of the fuel cell shown in FIG. 3, in which the MEA in Comparative example 9 was assembled, was measured under the same measurement conditions as in Example 7.

As a result, the cell voltage of 100 mV was indicated at a current density of 500 mA/cm². It was revealed that when the electrolyte membrane comprising only S-PES in Comparative example 9 was used, the output power of the PEFC was very low operating at as high as 110° C., but when zirconium oxide hydrate ZrO₂.nH₂O was included, a high output power could be achieved even at a high temperature.

What is claimed is:

1. A proton-conductive composite electrolyte membrane, for a fuel cell, comprising:
a metal-oxide hydrate with proton conductivity and a first organic macromolecular electrolyte, wherein
an intermediate layer is formed so as to enhance adhesion between the metal-oxide hydrate and the first organic macromolecular electrolyte.

2. The proton-conductive composite electrolyte membrane according to claim 1, wherein:
the intermediate layer is a second organic macromolecular electrolyte.

3. The proton-conductive composite electrolyte membrane according to claim 2, wherein:
the second organic macromolecular electrolyte is an aromatic hydrocarbon electrolyte.

4. A proton-conductive composite electrolyte membrane, for a fuel cell, comprising:
a metal-oxide hydrate with proton conductivity; a first organic macromolecular electrolyte having a proton donor; and an intermediate layer having a proton donor, wherein
the intermediate layer is formed between the metal-oxide hydrate and the first organic macromolecular electrolyte; and the proton donor of the intermediate layer has a larger ion exchange capacity than the proton donor of the first organic macromolecular electrolyte.

5. The proton-conductive composite electrolyte membrane according to claim 4, wherein:
the proton donor is a sulfonic acid group.

6. The proton-conductive composite electrolyte membrane according to claim 5, wherein:
the ion exchange capacity of the first organic macromolecular electrolyte is 0.75 meq/g or more.

7. The proton-conductive composite electrolyte membrane according to claim 5, wherein:
the ion exchange capacity of the intermediate layer is 1.67 meq/g or less.

8. The proton-conductive composite electrolyte membrane according to claim 1, wherein:
thickness of the intermediate layer is within a range from 10 nm to 10 μm.

9. The proton-conductive composite electrolyte membrane according to claim 1, wherein:
the metal-oxide hydrate is a zirconium oxide hydrate, tin oxide hydrate, or tungsten oxide hydrate.

10. The proton-conductive composite electrolyte membrane according to claim 1, wherein:
content of the metal-oxide hydrate is within a range from 5 to 80 wt %.

11. An electrolyte membrane assembly, comprising:
a cathode catalyst layer for reducing an oxidant gas; an anode catalyst layer for oxidizing a fuel; and the proton-conductive composite electrolyte membrane according to claim 1, wherein the proton-conductive composite electrolyte membrane is interposed between the cathode catalyst layer and the anode catalyst layer.

12. A fuel cell, comprising: the electrolyte membrane assembly according to claim 11.

13. The fuel cell according to claim 12, wherein:
the fuel cell uses a hydrogen gas or methanol as a fuel.
